(19) United States
(12) Patent Application Publication
(10) Pub. No.: US 2014/0097945 A1
(43) Pub. Date: Apr. 10, 2014

(54) Wireless Digital Signal-Controlled Switch System

(71) Applicant: Shih-Yao CHEN, New Taipei City (TW)

(72) Inventor: Shih-Yao CHEN, New Taipei City (TW)

(21) Appl. No.: 13/647,564

(22) Filed: Oct. 9, 2012

(51) Int. Cl. G08C 19/16

(52) U.S. Cl. 340/12.5

(57) ABSTRACT

A wireless digital signal-controlled switch system includes a Wi-Fi embedded RF module for receiving a RF signal from a mobile communication device, a control module with a CPU electrically connected to the Wi-Fi embedded RF module for receiving the RF signal from the Wi-Fi embedded RF module and processing the RF signal, and a relay module electrically connected between a power source and electrical home appliances and controllable by the CPU of the control module to turn on/off the electrical home appliances and to control the operation of the electrical home appliances.

### BACKGROUND OF THE INVENTION

1. Field of the Invention

The present invention relates to wireless switch technology and more particularly, to wireless digital signal-controlled switch system, which allows the user to control the operation of electrical home appliances at a remote place over a Wi-Fi network.

2. Description of the Related Art

Relay circuits are commonly used in electrical home appliances to control high-power circuits. A relay, either mechanical or electronic, is turned on or off by means of a low-power switched circuit. When the switch on the low-power circuit is turned on, the relay is actuated and the path for electric current in the high-power circuit is completed.

Conventionally, an electrical home appliance has a manual on/off switch switchable by a finger between two positions to turn on or turn off the power loop. In recent years, most electrical home appliances, such as TV, air cooler, etc., provide a remote control function. A user can control the operation of a remote control electrical home appliance at a remote place using a remote controller.

Conventional electrical home appliance remote controllers are commonly of PIR (Passive Infra-Red) design, their working range is limited. Therefore, these conventional remote controllers are not workable for long distance applications.

### SUMMARY OF THE INVENTION

The present invention has been accomplished under the circumstances in view. It is the main object of the present invention to provide a wireless digital signal-controlled switch system, which enables a user to control the operation of electrical home appliances at a remote place over a Wi-Fi network.

It is another object of the present invention to provide a wireless digital signal-controlled switch system, which allows a user to control the operation of electrical home appliances at a remote place by means of a smart phone, tablet computer, mobile personal computer or any other mobile communication device.

To achieve these and other objects of the present invention, a wireless digital signal-controlled switch system comprises a Wi-Fi embedded RF module adapted to receive a RF signal from a mobile communication device, a control module electrically connected to the Wi-Fi embedded RF module and comprising a CPU (central processing unit) adapted to receive and process the RF signal, and a relay module electrically connected to the control module. The relay module comprises at least one relay. Each relay comprises an input end electrically connected to a power source, and an output end terminating in a controlled terminal.

Further, the CPU (central processing unit) of the control module is programmable.

Further, the controlled terminal has built therein a wireless remote control output terminal.

Further, the controlled terminal of each relay of the relay module is an electrical home appliance.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram of a wireless digital signal-controlled switch system in accordance with the present invention.

### DETAILED DESCRIPTION OF THE PREFERRED EMBODIMENT

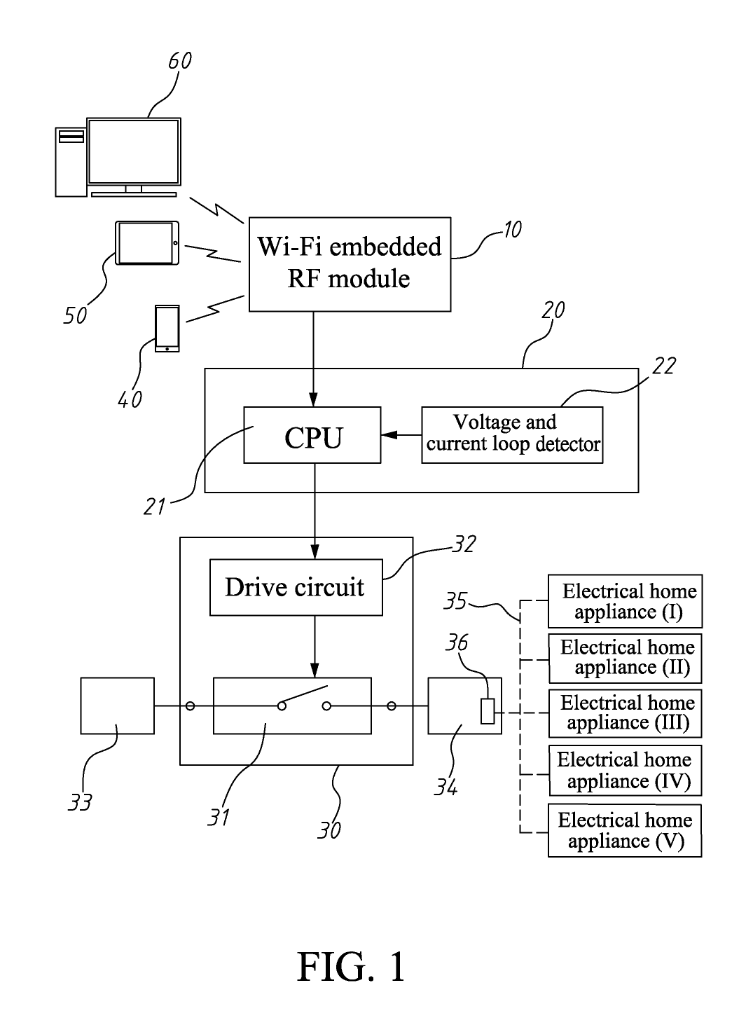

Referring to FIG. 1, a wireless digital signal-controlled switch system in accordance with the present invention is shown comprising a Wi-Fi embedded RF module 10, a control module 20 electrically connected to the Wi-Fi embedded RF module 10, and a relay module 30 electrically connected to the control module 20.

The Wi-Fi embedded RF module 10 is capable of receiving RF signals from a mobile communication device, such as smart phone 40, tablet computer 50, mobile personal computer 60, etc., over a Wi-Fi network.

The control module 20 comprises a CPU (Central Processing Unit) 21, and a voltage and current loop detector 22 electrically connected to the CPU 21. The CPU 21 has built therein memory means, for example, ROM (read only memory) and/or RAM (random access memory) and Wi-Fi chips, and is operable through Linux, Android or other like operating system and related micro application software to decode and transcode control data received from the smart phone 40, tablet computer 50, mobile personal computer 60 or other mobile communication device subject to a predetermined communication protocol interface into respective control signals.

The aforesaid CPU 21 is programmable to fit the product characteristics of different electrical appliances from different suppliers. Thus, the CPU 21 can be programmed to transcode control commands received from the smart phone 40, tablet computer 50 or other mobile communication device into a corresponding wireless remote control band signal to control the operation of a particular electrical appliance.

The aforesaid relay module 30 comprises at least one relay 31, and a drive circuit 32 electrically connected to the at least one relay 31 and controllable by the control module 20 to turn on/off the at least one relay 31. Each relay 31 has its one end terminating in a power input terminal 33 (AC power source), and its other end terminating in a controlled terminal 34 that has built therein a wireless remote control output terminal 36. In this embodiment, various electrical home appliances 35 numbered, for example, from 1 through 5, including air cooler, TV, lighting fixture, . . . etc., are electrically connected to the controlled terminal 34.

When the Wi-Fi embedded RF module 10 receives a Wi-Fi RF signal from the smart phone 40, tablet computer 50 or mobile personal computer 60, the Wi-Fi embedded RF module 10 immediately transmits the received signal to the CPU 21 of the control module 20 for processing, enabling the CPU 21 to drive the drive circuit 32 of the relay module 30 to turn on/off the relay 31, thereby turning on/off the power supply of the electrical home appliances 35 to be controlled, or linking the wireless remote control output terminal 36 so that the smart phone 40, tablet computer 50 or mobile personal computer 60 can control the operation of the electrical home appliances 35 at a remote place.

The use of the wireless digital signal-controlled switch system in accordance with the present invention enables the user to control the operation of various electrical home appliances at a remote place by means of a computer or mobile communication device. For example, even travelling abroad, the user control a variety of electrical home appliances that are installed in the user's home and electrically connected to the wireless digital signal-controlled switch system. Obviously, the invention involves an inventive step and has industrial applicability.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A wireless digital signal-controlled switch system, comprising:
a Wi-Fi embedded RF module adapted to receive a RF signal from a mobile communication device;
a control module electrically connected to said Wi-Fi embedded RF module, said control module comprising a CPU (central processing unit) adapted to receive and process said RF signal; and
a relay module electrically connected to said control module, said relay module comprising at least one relay, each said relay comprising an input end electrically connected to a power source and an output end terminating in a controlled terminal.

2. The wireless digital signal-controlled switch system as claimed in claim 1, wherein said CPU (central processing unit) is programmable.

3. The wireless digital signal-controlled switch system as claimed in claim 1, wherein said controlled terminal has built therein a wireless remote control output terminal.

4. The wireless digital signal-controlled switch system as claimed in claim 1, wherein said controlled terminal of each said relay is an electrical home appliance.

5. The wireless digital signal-controlled switch system as claimed in claim 2, wherein said controlled terminal of each said relay is an electrical home appliance.

6. The wireless digital signal-controlled switch system as claimed in claim 3, wherein said controlled terminal of each said relay is an electrical home appliance.

7. The wireless digital signal-controlled switch system as claimed in claim 1, wherein said mobile communication device is selected from the group of smart phone, tablet computer, mobile personal computer.

8. The wireless digital signal-controlled switch system as claimed in claim 2, wherein said mobile communication device is selected from the group of smart phone, tablet computer, mobile personal computer.

9. The wireless digital signal-controlled switch system as claimed in claim 3, wherein said mobile communication device is selected from the group of smart phone, tablet computer, mobile personal computer.
